(19) United States
(12) Patent Application Publication
(10) Pub. No.: US 2023/0026454 A1
(43) Pub. Date: Jan. 26, 2023

(54) Data Center Rack Including an Ultracapacitor Module

(71) Applicant: KYOCERA AVX Components Corporation, Fountain Inn, SC (US)

(72) Inventors: Jeffrey Cain, Greenville, SC (US); Joseph N. Hock, Surfside Beach, SC (US); Shelby Bartley, Simpsonville, SC (US)

(21) Appl. No.: 17/856,086

(22) Filed: Jul. 1, 2022

Related U.S. Application Data
(60) Provisional application No. 63/218,566, filed on Jul. 6, 2021.

(51) Int. Cl. H02J 7/34; G06F 1/26; H02M 3/158

(52) U.S. Cl. CPC H02J 7/345; G06F 1/26; H02M 3/1582; H02J 2207/50

(57) ABSTRACT

A data center rack is disclosed. The data center rack comprises a plurality of chamber openings including computing devices; and at least one chamber opening including a mounted ultracapacitor module comprising a plurality of ultracapacitors. A data center comprising a data center rack is also disclosed.

### CROSS-REFERENCE TO RELATED APPLICATION

The present application claims filing benefit of U.S. Provisional Patent Application Ser. No. 63/218,566 having a filing date of Jul. 6, 2021, and which is incorporated herein by reference in its entirety.

### BACKGROUND OF THE INVENTION

Data centers include racks which contain computing devices and associated components typically for storage, processing, and/or distribution or large amounts of information. These data centers may also include a power supply so that the data centers remain fully operational. Traditionally, the power supply has consisted of a battery system, such as a lead acid battery or lithium ion battery system. For instance, these systems may include a plurality of batteries that are electrically connected for providing an adequate power supply to the data center and the racks. However, in the instance there is a failure in the power supply, there is a desire to provide an alternative backup system capable of providing the necessary power for the data center racks. In addition, the backup power supply may not be located in proximity to the data center racks and may be located in another physical location.

As a result, a need currently exists for an improved power supply for a data center rack.

### SUMMARY OF THE INVENTION

In accordance with one embodiment of the present invention, a data center rack is disclosed. The data center rack comprises: a plurality of chamber openings including computing devices and at least one chamber opening including a mounted ultracapacitor module comprising a plurality of ultracapacitors

In accordance with another embodiment of the present invention, a data center is disclosed. The data center comprising a data center rack comprising a plurality of chamber openings including computing devices and at least one chamber opening including a mounted ultracapacitor module comprising a plurality of ultracapacitors

Other features and aspects of the present invention are set forth in greater detail below.

### BRIEF DESCRIPTION OF THE DRAWINGS

A full and enabling disclosure of the present invention, including the best mode thereof, directed to one of ordinary skill in the art, is set forth more particularly in the remainder of the specification, which makes reference to the appended figure in which:

FIG. 1 illustrates an embodiment of a data center rack;

FIG. 2 illustrates a perspective view of an embodiment of a rack mountable ultracapacitor module;

FIG. 3 illustrates a perspective view of an embodiment of a rack mountable ultracapacitor module;

FIG. 4 illustrates an embodiment of the housing of the ultracapacitor;

FIG. 5 illustrates an embodiment of a current collector that may be employed in the ultracapacitor;

FIG. 6 illustrates an embodiment of a current collector/carbonaceous coating configuration that may be employed in the ultracapacitor; and

FIG. 7 illustrates an embodiment for forming an electrode assembly that can be used in the ultracapacitor.

Repeat use of reference characters in the present specification and drawing is intended to represent same or analogous features or elements of the invention.

### DETAILED DESCRIPTION OF REPRESENTATIVE EMBODIMENTS

It is to be understood by one of ordinary skill in the art that the present discussion is a description of exemplary embodiments only, and is not intended as limiting the broader aspects of the present invention, which broader aspects are embodied in the exemplary construction.

Generally speaking, the present invention is directed to a data center rack including an ultracapacitor module mounted therein. The present inventors have discovered that by utilizing an ultracapacitor module directly within the rack, various benefits may be realized. For instance, the ultracapacitor module may be able to provide the necessary power for the computing devices within the data center rack, in particular as a backup system to a primary power source. Accordingly, such rack-mountable ultracapacitor modules may be able to serve as a backup system at a lower cost than other alternatives, such as backup battery systems. In addition, by providing the ultracapacitor module directly within the data center rack, various other benefits may be realized. For instance, the location may allow for the ultracapacitor module to be easily removed and replaced if necessary thereby minimizing disruption. Similarly, the ultracapacitor module is located more in proximity to the computing devices for which it may provide power.

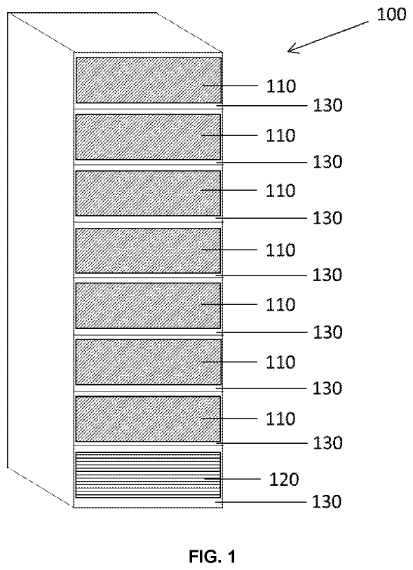

In general, a data center is an area that houses computer systems and associated components typically for storage, processing, and/or distribution or large amounts of information. Generally, these data centers utilize one or more data center racks including computing devices. The data center racks may be communicatively coupled to a network. The data center rack is further illustrated in FIG. 1. As illustrated, the data center rack 100 may include a plurality of chamber openings 130 for receiving rack-mounted computing devices 110. In this regard, the data center rack 100 may include one or more rack-mounted computing devices 110. As illustrated, the computing devices may be held in a vertical array. However, it should also be understood that the computing devices may be presented in a horizontal array. Similarly, the computing devices may be presented in a combination of vertical and horizontal arrays.

Furthermore, within each chamber opening 130 in the rack for a computing device, the data center rack may have a plurality of connection openings on the back of the chamber. Such plurality of connection openings may facilitate connection of the computing devices. Furthermore, the types of computing devices is not necessarily limited by the present invention. For instance, the computing devices may include servers and associated power supplies, network switches, etc. The computing devices may have stored thereon operating systems and applications executing within the operating systems.

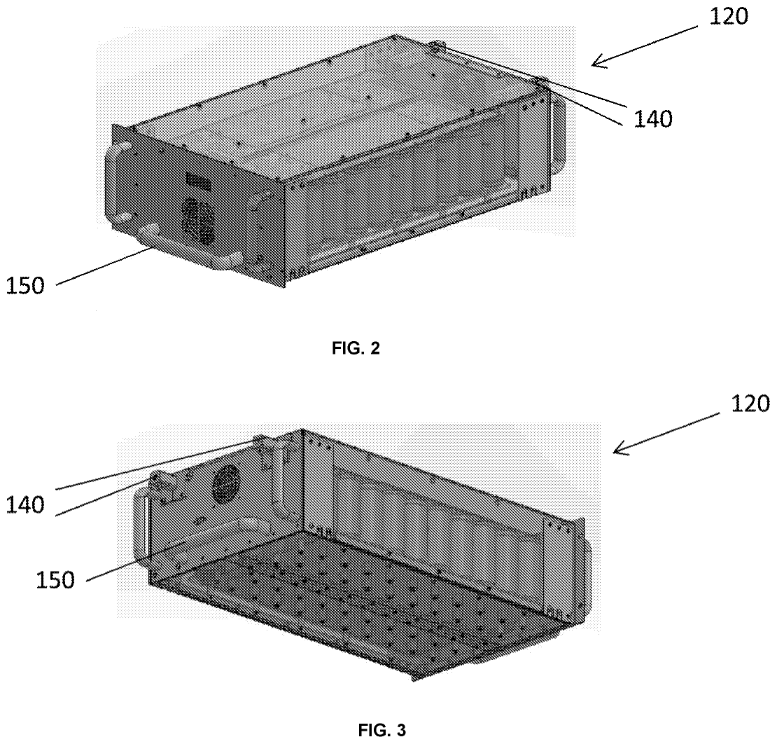

In addition, as illustrated, the data center rack includes at least one ultracapacitor module 120 within a chamber opening 130. The ultracapacitor module is further illustrated in FIGS. 2 and 3. The ultracapacitor module may be mounted horizontally such that it is in a vertical array. In one embodiment, the ultracapacitor module may be mounted vertically such that it is in a horizontal array. In addition, as illustrated in FIGS. 2 and 3, the ultracapacitor module may include terminals 140 that allow for connection through the connection openings of the data center rack. Such connection may then allow for providing power to the data center rack and the computing devices, in particular as a backup system.

In one embodiment, the data center rack may include only one rack-mounted ultracapacitor module. In another embodiment, the data center rack may include more than one ultracapacitor module. For instance, the data center rack may include two ultracapacitor modules or three ultracapacitor modules. In one embodiment, the data center rack may include a combination of an ultracapacitor module and a battery module.

While the aforementioned provides a description of a data center rack, it should be understood that the configuration and orientation of the data center rack(s) is not necessarily limited by the present invention. Furthermore, it should be understood that the data center racks may be provided within a data center. For instance, the data center may include 1 or more, such as 2 or more, such as 3 or more, such as 5 or more, such as 10 or more, such as 20 or more, such as 50 or more, such as 100 or more racks. In this regard, it should be understood that the number of data center racks within a data center is not necessarily limited by the present invention.

The ultracapacitor module includes a plurality of ultracapacitors and an enclosure for housing the plurality of ultracapacitors. In one embodiment, as mentioned above, the ultracapacitors within the module are electrically connected to the terminals 140 as illustrated in FIGS. 2 and 3 to allow for providing power to the computing devices. Such external terminals may be provided on the first and/or last ultracapacitor in the connection of ultracapacitors. Furthermore, as also illustrated in FIGS. 2 and 3, the ultracapacitor module may include one or more handles 150 to allow for easy manipulation of the ultracapacitor module. For instance, the handle 150 may allow for relatively easy insertion and removal of the ultracapacitor module from the data center rack. Furthermore, the handle 150 may be present on the front, the back, or the front and the back of the ultracapacitor module. Without intending to be limited, the front and/or back would be the ends of the ultracapacitor module visible when inserted into the opening of the data center rack.

The enclosure may include any number of top, bottom, and/or side enclosure members to form the enclosure. In this regard, the configuration of the enclosure of the ultracapacitor module is not necessarily limited by the present invention. In this regard, the enclosure members may be connected to one another using methods known in the art. For instance, such methods or techniques may include interlocking mechanisms and/or fasteners. In addition, the enclosure members may be made from any material known in the art that can provide the module and enclosure with structural integrity. For instance, the enclosure members may be made from a metal. The metal may include, but is not limited to, silver, copper, gold, aluminum, molybdenum, zinc, lithium, tungsten, nickel, iron, palladium platinum, tin, an alloy thereof, or a combination thereof. Alloys may include, but are not limited to, steel (e.g., stainless steel), brass, bronze, etc. In one embodiment, a metal such as aluminum, in particular anodized aluminum may be utilized. In another embodiment, the enclosure members may be made from a polymer. For example, the polymer may be a thermoplastic or a thermoset. In one particular embodiment, the polymer may be a thermoplastic polymer. For example, the thermoplastic polymer may include, but is not limited to, a polyolefin (e.g., polyethylene, polypropylene, etc.), a polyamide (e.g., nylon), a styrene (e.g., polystyrene, acrylonitrile butadiene styrene), an acrylic (e.g., polymethyl methacrylate), a polycarbonate, a polyetherketone, a polyarylene sulfide, a polyacetal, etc. In particular, the thermoplastic polymer may be one that is capable of being molded (e.g., injection molded, blow molded, etc.). In addition, the thermoplastic polymer may have a melting temperature of 30° C. or more, such as 40° C. or more, such as 50° C. or more, such as 75° C. or more, such as 100° C. or more, such as 125° C. or more, such as 150° C. or more, such as 200° C. or more. In this regard, the thermoplastic polymer may generally be a high performance polymer. In one embodiment, both enclosure members may be made from the same type of material. However, it should be understood that the enclosure members may also be made from different types of material.

The ultracapacitors within the ultracapacitor module may be connected to one another using means known in the art. For instance, the ultracapacitors may be connected using an interconnect (also referred to as a bus bar). In addition, the ultracapacitors may be electrically connected together in series or in parallel, depending on the particular properties desired. For instance, in one embodiment, the ultracapacitors may be electrically connected in series such that a terminal of a certain polarity (e.g., positive) of one ultracapacitor is connected to a terminal of opposite polarity (e.g., negative) of another ultracapacitor. Alternatively, in one embodiment, the ultracapacitors may be connected in parallel.

The type of interconnect and material utilized is not necessarily limited by the present invention. For instance, the interconnect may be formed from a variety of materials. The interconnect may comprise any suitable plastic, resin, metal, etc. so long as it is electrically conductive. In one embodiment, the interconnect is formed from a conductive material, such as a conductive metal. The conductive metal may include, but is not limited to, copper, tin, nickel, aluminum, etc., as well as alloys and/or coated metals. In one particular embodiment, the interconnect is formed from aluminum. In addition, in one embodiment, the interconnect may be relatively flat. Alternatively, the interconnect may be one having an increased surface area. Regarding the latter, the interconnect may have projections/protrusions or may also be formed from wires, braids, coils, etc.

Regardless, the ultracapacitors may be connected using an interconnect that attaches to or connects the respective terminals of the ultracapacitors. In this regard, the interconnect includes voids in which the terminals of the ultracapacitors are positioned. The interconnect surrounds the terminal allowing for electrical connection. The interconnect may be welded, such as laser welded, to the terminal of the ultracapacitors. However, it should be understood that other means may also be employed for connecting the interconnect to the terminals of the ultracapacitors. For instance, if the terminals have a screw configuration, the terminals may protrude through the voids of the interconnects whereby a nut could be utilized to connect the interconnect with the terminal and maintain structural integrity. It should be understood that in addition to the above, other means may also be utilized to secure the interconnect to the respective terminal.

The ultracapacitor module may also include an electronic board, such as a circuit board. For example, the circuit board may be a balancing circuit as generally known in the art. In general, the balancing circuit may be an active balancing circuit or a passive balancing circuit. For example, an active balancing circuit may include active components, such as a regulator. In general, a regulator can be any device that is operable to compare the input voltage with the reference voltage and provide an output. In some embodiments, the regulator can include a comparator and/or one or more switching elements provided in a single package (e.g., integrated circuit). Meanwhile, a passive balancing circuit may include passive components, such as a resistor. As indicated below, the ultracapacitors may be presented in banks. In this regard, in one embodiment, each individual bank may have its own circuit board.

The ultracapacitor module may also a control board. The control board may include electronic components to assist with the operation of the ultracapacitor module as well as an end-use application. The control board may be secured to the ultracapacitor module. As indicated below, the ultracapacitors may be presented in banks. In this regard, in one embodiment, each individual bank may have its own control board.

The ultracapacitor module may include a switch mode power supply on its output. For instance, the ultracapacitor module may include a converter. The converter may be a buck converter, a boost converter, or a buck/boost converter. In one embodiment, the converter may be a buck/boost converter. In another embodiment, the converter may be a buck converter. In a further embodiment, the converter may be a boost converter. In this regard, if the voltage of the ultracapacitors is affected, the converter may allow for the output voltage of the ultracapacitor module to be as desired. For example, in one embodiment, the output voltage may be converted to be about 48 V.

The ultracapacitor module may also include a cooling device. For instance, in one embodiment, the ultracapacitor module may include a fan that can be utilized to cool the components of the ultracapacitor module.

Ultracapacitor

As indicated herein, the present invention is directed to a rack-mountable ultracapacitor module including a plurality of ultracapacitors. The number of ultracapacitors utilized within the module are not necessarily limited by the present invention. For instance, the module may include at least 2, such as at least 4, such as at least 6, such as at least 10, such as at least 14, such as at least 18, such as at last 24, such as at last 30, such as at last 40, such as at least 50 ultracapacitors, such as at least 54 ultracapacitors. While not limited, the module may include 500 or less, such as 400 or less, such as 300 or less, such as 200 or less, such as 100 or less, such as 80 or less, such as 60 or less, such as 40 or less ultracapacitors.

In one embodiment, the ultracapacitors may be provided all together within one ultracapacitor bank. Alternatively, the ultracapacitors may be provided in more than one bank, which are then connected to form the module. For instance, if the ultracapacitor module includes 54 ultracapacitors, the ultracapacitor may include 3 banks of 18 capacitors each wherein the banks are electrically connected to provide the necessary power. Accordingly, the ultracapacitor module may include more than 1 bank, such as 2 banks, such as 3 banks, such as 4 banks to 10 banks of less, such as 8 banks or less, such as 6 banks or less, such as 5 banks or less. Each bank may include at least 2, such as at least 4, such as at least 6, such as at least 10, such as at least 14, such as at least 18 ultracapacitors. While not necessarily limited, each bank may include 100 or less, such as 80 or less, such as 50 or less, such as 40 or less, such as 30 or less, such as 20 or less, such as 15 or less ultracapacitors. In one embodiment, each bank may include the same number of ultracapacitors.

Furthermore, each bank may be electrically connected in series in one embodiment. In another embodiment, each bank may be electrically connected in parallel. If the latter, the individual ultracapacitors within the bank may be electrically connected in series.

Furthermore, the ultracapacitors utilized within the enclosure of the ultracapacitor module are not necessarily limited by the present invention. In general, the ultracapacitor includes a housing within which an electrode assembly and electrolyte are retained and sealed. The ultracapacitors also include terminals electrically connected to respective electrodes within the electrode assembly. For instance, in one embodiment, at least one external terminal may be provided on a top surface of the ultracapacitor while a second external terminal may be provided on a bottom surface of the ultracapacitor. In this regard, the external terminals extend from opposing ends of the electrode assembly and ultracapacitor. In another embodiment, both external terminals may be provided on the same surface, such as the top surface, of the ultracapacitor. In this regard, the external terminals may extend from the same side of the electrode assembly and ultracapacitor.

Electrode Assembly

In general, the ultracapacitor contains an electrode assembly including a first electrode, a second electrode, and a separator. For instance, the first electrode typically includes a first electrode containing a first carbonaceous coating (e.g., activated carbon particles) electrically coupled to a first current collector, and a second electrode typically includes a second carbonaceous coating (e.g., activated carbon particles) electrically coupled to a second current collector. A separator may also be positioned between the first electrode and the second electrode. In addition, the ultracapacitor contains first and second terminals that are electrically connected to first and second electrodes, respectively.

Various embodiments of such an assembly are described in more detail below.

Electrodes

As indicated above, the ultracapacitor includes an electrode assembly including a first electrode and a second electrode. The electrodes employed within the assembly generally contain a current collector. The current collectors may be formed from the same or different materials. For instance, in one embodiment, the current collectors of each electrode are formed from the same material. Regardless, each collector is typically formed from a substrate that includes a conductive metal, such as aluminum, stainless steel, nickel, silver, palladium, etc., as well as alloys thereof. Aluminum and aluminum alloys are particularly suitable for use in the present invention.

The current collector substrate may be in the form of a foil, sheet, plate, mesh, etc. The substrate may also have a relatively small thickness, such as about 200 micrometers or less, such as about 150 micrometers or less, such as about 100 micrometers or less, such as about 80 micrometers or less, such as about 50 micrometers or less, such as about 40 micrometers or less, such as about 30 micrometers or less. The substrate may have a thickness of about 1 micrometer or more, such as about 5 micrometers or more, such as about 10 micrometers or more, such as about 20 micrometers or more.

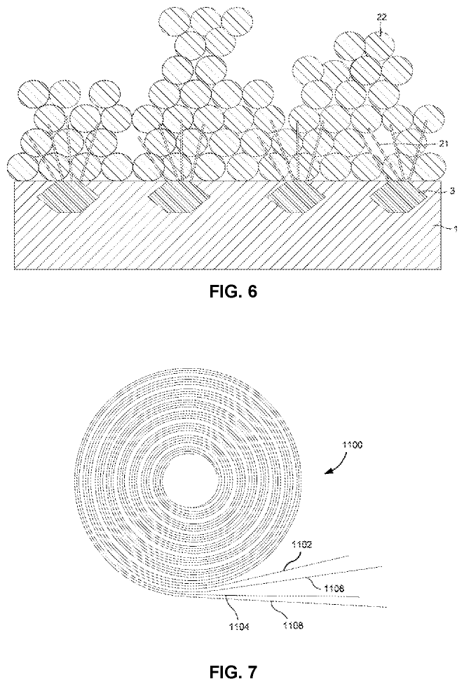

Although by no means required, the surface of the substrate may be treated. For example, in one embodiment, the surface may be roughened, such as by washing, etching, blasting, etc. In certain embodiments, the current collector may contain a plurality of fiber-like whiskers that project outwardly from the substrate. Without intending to be limited by theory, it is believed that these whiskers can effectively increase the surface area of the current collector and also improve the adhesion of the current collector to the corresponding electrode. This can allow for the use of a relatively low binder content in the first electrode and/or second electrode, which can improve charge transfer and reduce interfacial resistance and consequently result in very low ESR values. The whiskers are typically formed from a material that contains carbon and/or a reaction product of carbon and the conductive metal. In one embodiment, for example, the material may contain a carbide of the conductive metal, such as aluminum carbide (Al₄C₃). Referring to FIG. 5, for instance, one embodiment of a current collector is shown that contains a plurality of whiskers 21 projecting outwardly from a substrate 1. If desired, the whiskers 21 may optionally project from a seed portion 3 that is embedded within the substrate 1. Similar to the whiskers 21, the seed portion 3 may also be formed from a material that contains carbon and/or a reaction product of carbon and the conductive metal, such as a carbide of the conductive metal (e.g., aluminum carbide). Further, FIG. 6 illustrates an electrode including the aforementioned current collector having a plurality of whiskers 21 projecting outwardly from a substrate 1 in combination with a carbonaceous coating 22 as described herein.

The manner in which such whiskers are formed on the substrate may vary as desired. In one embodiment, for instance, the conductive metal of the substrate is reacted with a hydrocarbon compound. Examples of such hydrocarbon compounds may include, for instance, paraffin hydrocarbon compounds, such as methane, ethane, propane, n-butane, isobutane, pentane, etc.; olefin hydrocarbon compounds, such as ethylene, propylene, butene, butadiene, etc.; acetylene hydrocarbon compounds, such as acetylene; as well as derivatives or combinations of any of the foregoing. It is generally desired that the hydrocarbon compounds are in a gaseous form during the reaction. Thus, it may be desired to employ hydrocarbon compounds, such as methane, ethane, and propane, which are in a gaseous form when heated. Although not necessarily required, the hydrocarbon compounds are typically employed in a range of from about 0.1 parts to about 50 parts by weight, and in some embodiments, from about 0.5 parts by weight to about 30 parts by weight, based on 100 parts by weight of the substrate. To initiate the reaction with the hydrocarbon and conductive metal, the substrate is generally heated in an atmosphere that is at a temperature of about 300° C. or more, in some embodiments about 400° C. or more, and in some embodiments, from about 500° C. to about 650° C. The time of heating depends on the exact temperature selected, but typically ranges from about 1 hour to about 100 hours. The atmosphere typically contains a relatively low amount of oxygen to minimize the formation of a dielectric film on the surface of the substrate. For example, the oxygen content of the atmosphere may be about 1% by volume or less.

The electrodes used in the ultracapacitor also contain carbonaceous materials that are coated onto opposing sides of the current collectors. While they may be formed from the same or different types of materials and may contain one or multiple layers, each of the carbonaceous coatings generally contains at least one layer that includes activated particles. In certain embodiments, for instance, the activated carbon layer may be directly positioned over the current collector and may optionally be the only layer of the carbonaceous coating. Examples of suitable activated carbon particles may include, for instance, coconut shell-based activated carbon, petroleum coke-based activated carbon, pitch-based activated carbon, polyvinylidene chloride-based activated carbon, phenolic resin-based activated carbon, polyacrylonitrile-based activated carbon, and activated carbon from natural sources such as coal, charcoal, or other natural organic sources.

In certain embodiments, it may be desired to selectively control certain aspects of the activated carbon particles, such as their particle size distribution, surface area, and pore size distribution to help improve ion mobility for certain types of electrolytes after being subjected to one or more charge-discharge cycles. For example, at least 50% by volume of the particles (D50 size) may have a size in the range of from about 0.01 micrometers or more, such as about 0.1 micrometers or more, such as about 0.5 micrometers or more, such as about 1 micrometer or more to about 30 micrometers or less, such as about 25 micrometers or less, such as about 20 micrometers or less, such as about 15 micrometers or less, such as about 10 micrometers or less. At least 90% by volume of the particles (D90 size) may likewise have a size in the range of from about 2 micrometers or more, such as about 5 micrometers or more, such as about 6 micrometers or more to about 40 micrometers or less, such as about 30 micrometers or less, such as about 20 micrometers or less, such as about 15 micrometers or less. The BET surface may also range from about 900 m²/g or more, such as about 1,000 m²/g or more, such as about 1,100 m²/g or more, such as about 1,200 m²/g or more to about 3,000 m²/g or less, such as about 2,500 m²/g or less, such as about 2,000 m²/g or less, such as about 1,800 m²/g or less, such as about 1,500 m²/g or less.

In addition to having a certain size and surface area, the activated carbon particles may also contain pores having a certain size distribution. For example, the amount of pores less than about 2 nanometers in size (i.e., “micropores”) may provide a pore volume of about 50 vol. % or less, such as about 40 vol. % or less, such as about 30 vol. % or less, such as about 20 vol. % or less, such as about 15 vol. % or less, such as about 10 vol. % or less, such as about 5 vol. % or less of the total pore volume. The amount of pores less than about 2 nanometers in size (i.e., “micropores”) may provide a pore volume of about 0 vol % or more, such as about 0.1 vol % or more, such as about 0.5 vol % or more, such as 1 vol % or more of the total pore volume. The amount of pores between about 2 nanometers and about 50 nanometers in size (i.e., “mesopores”) may likewise be about 20 vol. % or more, such as about 25 vol. % or more, such as about 30 vol. % or more, such as about 35 vol. % or more, such as about 40 vol. % or more, such as about 50 vol. % or more of the total pore volume. The amount of pores between about 2 nanometers and about 50 nanometers in size (i.e., “mesopores”) may be about 90 vol. % or less, such as about 80 vol. % or less, such as about 75 vol. % or less, such as about 65 vol. % or less, such as about 55 vol. % or less, such as about 50 vol. % or less of the total pore volume. Finally, the amount of pores greater than about 50 nanometers in size (i.e., “macropores”) may be about 1 vol. % or more, such as about 5 vol. % or more, such as about 10 vol. % or more, such as about 15 vol. % or more of the total pore volume. The amount of pores greater than about 50 nanometers in size (i.e., “macropores”) may be about 50 vol. % or less, such as about 40 vol. % or less, such as about 35 vol. % or less, such as about 30 vol. % or less, such as about 25 vol. % or less of the total pore volume. The total pore volume of the carbon particles may be in the range of from about 0.2 cm³/g or more, such as about 0.4 cm³/g or more, such as about, 0.5 cm³/g or more to about 1.5 cm³/g or less, such as about 1.3 cm³/g or less, such as about 1.0 cm³/g or less, such as about 0.8 cm³/g or less. The median pore width may be about 8 nanometers or less, such as about 5 nanometers or less, such as about 4 nanometers or less. The median pore width may be about 1 nanometer or more, such as about 2 nanometers or more. The pore sizes and total pore volume may be measured using nitrogen adsorption and analyzed by the Barrett-Joyner-Halenda (“BJH”) technique as is well known in the art.

One unique aspect of the present invention is that the electrodes need not contain a substantial amount of binders conventionally employed in ultracapacitor electrodes. That is, binders may be present in an amount of about 60 parts or less, such as about 40 parts or less, such as about 30 parts or less, such as about 25 parts or less, such as about 20 parts or less to about 1 part or more, such as about 5 parts or more per 100 parts of carbon in the carbonaceous coating. Binders may, for example, constitute about 15 wt. % or less, such as about 10 wt. % or less, such as about 8 wt. % or less, such as about 5 wt. % or less, such as about 4 wt. % or less of the total weight of the carbonaceous coating. The binders may constitute about 0.1 wt. % or more, such as about 0.5 wt. % or more, such as about 1 wt. % or more of the total weight of the carbonaceous coating.

Nevertheless, when employed, any of a variety of suitable binders can be used in the electrodes. For instance, water-insoluble organic binders may be employed in certain embodiments, such as styrene-butadiene copolymers, polyvinyl acetate homopolymers, vinyl-acetate ethylene copolymers, vinyl-acetate acrylic copolymers, ethylene-vinyl chloride copolymers, ethylene-vinyl chloride-vinyl acetate terpolymers, acrylic polyvinyl chloride polymers, acrylic polymers, nitrile polymers, fluoropolymers such as polytetrafluoroethylene or polyvinylidene fluoride, polyolefins, etc., as well as mixtures thereof. Water-soluble organic binders may also be employed, such as polysaccharides and derivatives thereof. In one particular embodiment, the polysaccharide may be a nonionic cellulosic ether, such as alkyl cellulose ethers (e.g., methyl cellulose and ethyl cellulose); hydroxyalkyl cellulose ethers (e.g., hydroxyethyl cellulose, hydroxypropyl cellulose, hydroxypropyl hydroxybutyl cellulose, hydroxyethyl hydroxypropyl cellulose, hydroxyethyl hydroxybutyl cellulose, hydroxyethyl hydroxypropyl hydroxybutyl cellulose, etc.); alkyl hydroxyalkyl cellulose ethers (e.g., methyl hydroxyethyl cellulose, methyl hydroxypropyl cellulose, ethyl hydroxyethyl cellulose, ethyl hydroxypropyl cellulose, methyl ethyl hydroxyethyl cellulose and methyl ethyl hydroxypropyl cellulose); carboxyalkyl cellulose ethers (e.g., carboxymethyl cellulose); and so forth, as well as protonated salts of any of the foregoing, such as sodium carboxymethyl cellulose.

If desired, other materials may also be employed within an activated carbon layer of the carbonaceous materials. For example, in certain embodiments, a conductivity promoter may be employed to further increase electrical conductivity. Exemplary conductivity promoters may include, for instance, carbon black, graphite (natural or artificial), graphite, carbon nanotubes, nanowires or nanotubes, metal fibers, graphenes, etc., as well as mixtures thereof. Carbon black is particularly suitable in one embodiment. In another embodiment, carbon nanotubes are particularly suitable. When employed, conductivity promoters typically constitute about 60 parts or less, such as about 40 parts or less, such as about 30 parts or less, such as about 25 parts or less, such as about 20 parts or less to about 1 part or more, such as about 5 parts or more per 100 parts of carbon in the carbonaceous coating. Conductivity promoters may, for example, constitute about 15 wt. % or less, such as about 10 wt. % or less, such as about 8 wt. % or less, such as about 5 wt. % or less, such as about 4 wt. % or less of the total weight of the carbonaceous coating. The conductivity promoters may constitute about 0.1 wt. % or more, such as about 0.5 wt. % or more, such as about 1 wt. % or more of the total weight of the carbonaceous coating. Meanwhile, activated carbon particles likewise typically constitute 85 wt. % or more, such as about 90 wt. % or more, such as about 95 wt. % or more, such as about 97 wt. % or more of the total weight of the carbonaceous coating. The activated carbon particles may constitute less than 100 wt. %, such as about 99.5 wt. % or less, such as about 99 wt. % or less, such as about 98 wt. % or less of the total weight of the carbonaceous coating.

The particular manner in which a carbonaceous material is coated onto to the sides of a current collector may vary as is well known to those skilled in the art, such as printing (e.g., rotogravure), spraying, slot-die coating, drop-coating, dip-coating, etc. Regardless of the manner in which it is applied, the resulting electrode is typically dried to remove moisture from the coating, such as at a temperature of about 100° C. or more, in some embodiments about 200° C. or more, and in some embodiments, from about 300° C. to about 500° C. The electrode may also be compressed (e.g., calendared) to optimize the volumetric efficiency of the ultracapacitor. After any optional compression, the thickness of each carbonaceous coating may generally vary based on the desired electrical performance and operating range of the ultracapacitor. Typically, however, the thickness of a coating is from about 20 to about 200 micrometers, 30 to about 150 micrometers, and in some embodiments, from about 40 to about 100 micrometers. Coatings may be present on one or both sides of a current collector. Regardless, the thickness of the overall electrode (including the current collector and the carbonaceous coating(s) after optional compression) is typically within a range of from about 20 to about 350 micrometers, in some embodiments from about 30 to about 300 micrometers, and in some embodiments, from about 50 to about 250 micrometers.

Separator

As indicated above, the electrode assembly may include a separator positioned between the first electrode and the second electrode. The separator can enable electrical isolation of one electrode from another to help prevent an electrical short but still allow transport of ions between the two electrodes. In certain embodiments, for example, a separator may be employed that includes a cellulosic fibrous material (e.g., airlaid paper web, wet-laid paper web, etc.), nonwoven fibrous material (e.g., polyolefin nonwoven webs), woven fabrics, film (e.g., polyolefin film), etc. Cellulosic fibrous materials are particularly suitable for use in the ultracapacitor, such as those containing natural fibers, synthetic fibers, etc. Specific examples of suitable cellulosic fibers for use in the separator may include, for instance, hardwood pulp fibers, softwood pulp fibers, rayon fibers, regenerated cellulosic fibers, etc.

Regardless of the particular materials employed, the separator typically has a thickness of about 150 micrometers or less, such as about 100 micrometers or less, such as about 80 micrometers or less, such as about 50 micrometers or less, such as about 40 micrometers or less, such as about 30 micrometers or less. The separator may have a thickness of about 1 micrometer or more, such as about 5 micrometers or more, such as about 10 micrometers or more, such as about 20 micrometers or more.

Nonaqueous Electrolyte

In addition, the ultracapacitor may also include an electrolyte employed within the housing. The electrolyte is generally nonaqueous in nature and thus contains at least one nonaqueous solvent. To help extend the operating temperature range of the ultracapacitor, it is typically desired that the nonaqueous solvent have a relatively high boiling temperature, such as about 150° C. or more, in some embodiments about 200° C. or more, and in some embodiments, from about 220° C. to about 300° C. Particularly suitable high boiling point solvents may include, for instance, cyclic carbonate solvents, such as ethylene carbonate, propylene carbonate, butylene carbonate, vinylene carbonate, etc. Propylene carbonate is particularly suitable due to its high electric conductivity and decomposition voltage, as well as its ability to be used over a wide range of temperatures. Of course, other nonaqueous solvents may also be employed, either alone or in combination with a cyclic carbonate solvent. Examples of such solvents may include, for instance, open-chain carbonates (e.g., dimethyl carbonate, ethyl methyl carbonate, diethyl carbonate, etc.), aliphatic monocarboxylates (e.g., methyl acetate, methyl propionate, etc.), lactone solvents (e.g., butyrolactone valerolactone, etc.), nitriles (e.g., acetonitrile, glutaronitrile, adiponitrile, methoxyacetonitrile, 3-methoxypropionitrile, etc.), amides (e.g., N,N-dimethylformamide, N,N-diethylacetamide, N-methylpyrrolidinone), alkanes (e.g., nitromethane, nitroethane, etc.), sulfur compounds (e.g., sulfolane, dimethyl sulfoxide, etc.); and so forth.

The electrolyte also contains at least one ionic liquid, which may be dissolved in the nonaqueous solvent. While the concentration of the ionic liquid can vary, it is typically desired that the ionic liquid is present at a relatively high concentration. For example, the ionic liquid may be present in an amount of about 0.8 moles per liter (M) of the electrolyte or more, in some embodiments about 1.0 M or more, such as about 1.2 M or more, such as about 1.3 M or more, such as about 1.5 M or more. The ionic liquid may be present in an amount of about 2.0 M or less, such as about 1.8 M or less, such as about 1.5 M or less, such as about 1.4 M or less, such as about 1.3 M or less.

The ionic liquid is generally a salt having a relatively low melting temperature, such as about 400° C. or less, in some embodiments about 350° C. or less, in some embodiments from about 1° C. to about 100° C., and in some embodiments, from about 5° C. to about 50° C. The salt contains a cationic species and counterion. The cationic species contains a compound having at least one heteroatom (e.g., nitrogen or phosphorous) as a “cationic center.” Examples of such heteroatomic compounds include, for instance, unsubstituted or substituted organoquaternary ammonium compounds, such as ammonium (e.g., trimethylammonium, tetraethylammonium, etc.), pyridinium, pyridazinium, pyramidinium, pyrazinium, imidazolium, pyrazolium, oxazolium, triazolium, thiazolium, quinolinium, piperidinium, pyrrolidinium, quaternary ammonium spiro compounds in which two or more rings are connected together by a spiro atom (e.g., carbon, heteroatom, etc.), quaternary ammonium fused ring structures (e.g., quinolinium, isoquinolinium, etc.), and so forth. In one particular embodiment, for example, the cationic species may be an N-spirobicyclic compound, such as symmetrical or asymmetrical N-spirobicyclic compounds having cyclic rings. One example of such a compound has the following structure:

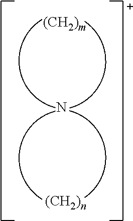

wherein m and n are independently a number from 3 to 7, and in some embodiments, from 4 to 5 (e.g., pyrrolidinium or piperidinium).

Suitable counterions for the cationic species may likewise include halogens (e.g., chloride, bromide, iodide, etc.); sulfates or sulfonates (e.g., methyl sulfate, ethyl sulfate, butyl sulfate, hexyl sulfate, octyl sulfate, hydrogen sulfate, methane sulfonate, dodecylbenzene sulfonate, dodecylsulfate, trifluoromethane sulfonate, heptadecafluorooctanesulfonate, sodium dodecylethoxysulfate, etc.); sulfosuccinates; amides (e.g., dicyanamide); imides (e.g., bis(pentafluoroethyl-sulfonyl)imide, bis(trifluoromethylsulfonyl)imide, bis(trifluoromethyl)imide, etc.); borates (e.g., tetrafluoroborate, tetracyanoborate, bis[oxalato]borate, bis[salicylato]borate, etc.); phosphates or phosphinates (e.g., hexafluorophosphate, diethylphosphate, bis(pentafluoroethyl)phosphinate, tris(pentafluoroethyl)-trifluorophosphate, tris(nonafluorobutyl)trifluorophosphate, etc.); antimonates (e.g., hexafluoroantimonate); aluminates (e.g., tetrachloroaluminate); fatty acid carboxylates (e.g., oleate, isostearate, pentadecafluorooctanoate, etc.); cyanates; acetates; and so forth, as well as combinations of any of the foregoing.

Several examples of suitable ionic liquids may include, for instance, spiro-(1,1′)-bipyrrolidinium tetrafluoroborate, triethylmethyl ammonium tetrafluoroborate, tetraethyl ammonium tetrafluoroborate, spiro-(1,1′)-bipyrrolidinium iodide, triethylmethyl ammonium iodide, tetraethyl ammonium iodide, methyltriethylammonium tetrafluoroborate, tetrabutylammonium tetrafluoroborate, tetraethylammonium hexafluorophosphate, etc.

Housing

The ultracapacitor of the present invention employs a housing within which the electrode assembly and electrolyte are retained. The manner in which the components are inserted into the housing may vary as is known in the art. For example, the electrodes and separator may be initially folded, wound, or otherwise contacted together to form an electrode assembly. The electrolyte may optionally be immersed into the electrodes of the assembly. In one particular embodiment, the electrodes, separator, and optional electrolyte may be wound into an electrode assembly having a “jelly-roll” configuration. Referring to FIG. 7, for instance, one embodiment of such a jellyroll electrode assembly 1100 is shown that contains a first electrode 1102, a second electrode 1104, and a separator 1106 positioned between the electrodes 1102 and 1104. In this particular embodiment, the electrode assembly 1100 also includes another separator 1108 that is positioned over the second electrode 1104. In this manner, each of two coated surfaces of the electrodes is separated by a separator, thereby maximizing surface area per unit volume and capacitance. While by no means required, the electrodes 1102 and 1104 are offset in this embodiment so as to leave their respective contact edges extending beyond first and second edges of the first and second separators 1106 and 1108, respectively. Among other things, this can help prevent “shorting” due to the flow of electrical current between the electrodes. However, it should be understood that other configurations may also be utilized. For instance, in another embodiment, the electrodes, separator, and optional electrolyte may be provided as an electrode assembly having a laminar configuration.

As indicated herein, the components may be provided within the housing of the ultracapacitor and optionally hermetically sealed. The nature of the housing may vary as desired. In certain embodiments, for example, the housing may contain a container that encloses the components of the ultracapacitor. For example, the housing may contain a metal container (“can”), such as those formed from tantalum, niobium, aluminum, nickel, hafnium, titanium, copper, silver, steel (e.g., stainless), alloys thereof, composites thereof (e.g., metal coated with electrically conductive oxide), and so forth. Aluminum is particularly suitable for use in the present invention. The metal container may have any of a variety of different shapes, such as cylindrical, D-shaped, etc. Cylindrically-shaped containers are particular suitable.

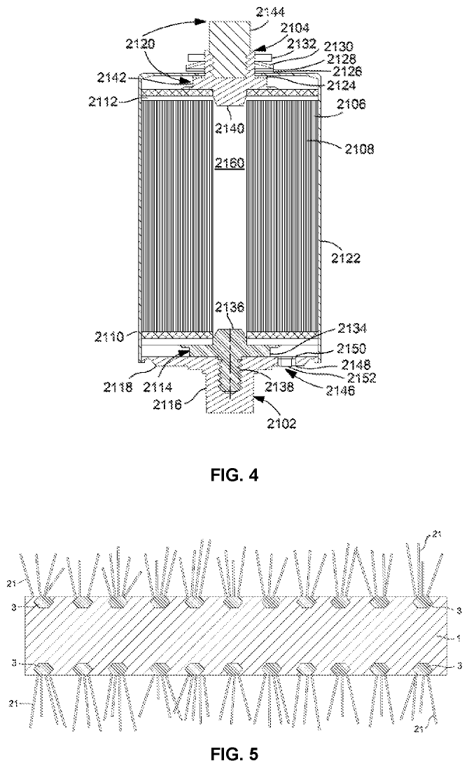

The electrode assembly may be sealed within the cylindrical housing using a variety of different techniques. Referring to FIG. 4, one embodiment of an ultracapacitor is shown that contains an electrode assembly 2108, which contains layers 2106 wound together in a jellyroll configuration as discussed above. In this particular embodiment, the ultracapacitor contains a first collector disc 2114, which contains a disc-shaped portion 2134, a stud portion 2136, and a fastener 2138 (e.g., screw). The collector disc 2114 is aligned with a first end of a hollow core 2160, which is formed in the center of the electrode assembly, and the stud portion 2136 is then inserted into an opening of the core so that the disc-shaped portion 2134 sits against the first end of the electrode assembly 2108 at a first contact edge 2110. A lid 2118 is welded (e.g., laser welded) to a first terminal post 2116, and a socket, which may be for example, threaded, is coupled to the fastener 2138. The ultracapacitor also contains a second collector disc 2120, which contains a disc-shaped portion 2142, a stud portion 2140, and a second terminal post 2144. The second collector disc 2120 is aligned with the second end of the hollow core 2160, and the stud portion 2140 is then inserted into the opening of the core so that the collector disc portion 2142 sits against the second end of the electrode assembly 2108.

A metal container 2122 (e.g., cylindrically-shaped can) is thereafter slid over the electrode assembly 2108 so that the second collector disc 2120 enters the container 2122 first, passes through a first insulating washer 2124, passes through an axial hole at an end of the container 2122, and then passes through a second insulating washer 2126. The second collector disc 2120 also passes through a flat washer 2128 and a spring washer 2130. A locknut 2132 is tightened over the spring washer 2130, which compresses the spring washer 2130 against the flat washer 2128, which in turn is compressed against the second insulating washer 2126. The second insulating washer 2126 is compressed against the exterior periphery of the axial hole in the metal container 2122, and as the second collector disc 2120 is drawn by this compressive force toward the axial hole, the first insulating washer 2124 is compressed between the second collector disc 2120 and an interior periphery of the axial hole in the container 2122. A flange on the first insulating washer 2124 inhibits electrical contact between the second collector disc 2120 and a rim of the axial hole. Simultaneously, the lid 2118 is drawn into an opening of the container 2122 so that a rim of the lid 2118 sits just inside a lip of the opening of the container 2122. The rim of the lid 2118 is then welded to the lip of the opening of the container 2122.

Once the locknut 2132 is tightened against the spring washer 2130, a hermetic seal may be formed between the axial hole, the first insulating washer 2124, the second insulating washer 2126, and the second collector disc 2120. Similarly, the welding of the lid 2118 to the lip of the container 2122, and the welding of the lid 2118 to the first terminal post 2116, may form another hermetic seal. A hole 2146 in the lid 2118 can remain open to serve as a fill port for the electrolyte described above. Once the electrolyte is in the can (i.e., drawn into the can under vacuum, as described above), a bushing 2148 is inserted into the hole 2146 and seated against a flange 2150 at an interior edge of the hole 2146. The bushing 2148 may, for instance, be a hollow cylinder in shape, fashioned to receive a plug 2152. The plug 2152, which is cylindrical in shape, is pressed into a center of the bushing 2148, thereby compressing the bushing 2148 against an interior of the hole 2146 and forming a hermetic seal between the hole 2146, the bushing 2148, and the plug 2152. The plug 2152 and the bushing 2148 may be selected to dislodge when a prescribed level of pressure is reached within the ultracapacitor, thereby forming an overpressure safety mechanism.

The embodiments described above generally refer to the use of a single electrode assembly in the ultracapacitor. It should of course be understood, however, that the capacitor of the present invention may also contain two or more electrode assemblies. For instance, in one such embodiment, for example, the ultracapacitor may include a stack of two or more electrode assemblies, which may be the same or different.

Properties and Applications

The ultracapacitor module as disclosed herein can be utilized for DC applications and can thus be utilized for data center racks. In this regard, the ultracapacitor module may have an output (e.g., a DC output) of 12 V or more, such as 16 V or more, such as 20 V or more, such as 24 V or more, such as 30 V or more, such as 36 V or more, such as 40 V or more, such as 48 V or more. In addition, the ultracapacitor module may have an output (e.g., a DC output) of 500 V or less, such as 400 V or less, such as 300 V or less, such as 250 V or less, such as 200 V or less, such as 180 V or less, such as 150 V or less, such as 120 V or less, such as 100 V or less, such as 80 V or less, such as 60 V or less, such as 50 V or less, such as 40 V or less.

Each individual ultracapacitor may have a certain voltage. For instance, each individual ultracapacitor may have a voltage of 2 V or more, such as 2.2 V or more, such as 2.5 V or more, such as 2.7 V or more, such as 3 V or more. The ultracapacitor may have a voltage of 5 V or less, such as 4 V or less, such as 3.5 V or less, such as 3.2 V or less, such as 3 V or less, such as 2.9 V or less. For instance, in one embodiment, the ultracapacitors may have a voltage of 2.7 V or 3.0 V. In one embodiment, the ultracapacitors may have a voltage of 2.7 V. In another embodiment, the ultracapacitors may have a voltage of 3.0 V.

Further, the ultracapacitor module may have a relatively high capacitance. For instance, the rated capacitance of the ultracapacitor module may be 50 F or more, such as 100 F or more, such as 200 F or more, such as 300 F or more, such as 400 F or more, such as 450 F or more, such as 500 F or more. The rated capacitance of the ultracapacitor module may be 1,000 F or less, such as 800 or less, such as 700 or less, such as 600 or less, such as 550 or less, such as 500 or less. Meanwhile, the rated capacitance of each individual ultracapacitor may also be relatively high. For instance, the rated capacitance of the ultracapacitor may be 50 F or more, such as 100 F or more, such as 200 F or more, such as 300 F or more, such as 500 F or more, such as 800 F or more, such as 1,000 F or more, such as 1,500 F or more, such as 2,000 F or more, such as 2,500 F or more, such as 3,000 F or more. The rated capacitance of the ultracapacitor may be 5,000 F or less, such as 4,000 F or less, such as 3,500 F or less, such as 3,000 F or less.

The ultracapacitor utilized according to the present invention may exhibit excellent electrical properties, in particular when exposed to high temperatures. For example, the ultracapacitor may exhibit a capacitance of about 6 Farads per cubic centimeter (“F/cm³”) or more, in some embodiments about 8 F/cm³ or more, in some embodiments from about 9 to about 100 F/cm³, and in some embodiments, from about 10 to about 80 F/cm³, measured at a temperature of 23° C., frequency of 120 Hz, and without an applied voltage. The ultracapacitor may also have a low equivalence series resistance (“ESR”), such as about 150 mohms or less, in some embodiments less than about 125 mohms, in some embodiments from about 0.01 to about 100 mohms, and in some embodiments, from about 0.05 to about 70 mohms, determined at a temperature of 23° C., frequency of 1 kHz, and without an applied voltage. As indicated above, the resulting ultracapacitor may exhibit a wide variety of beneficial electrical properties, such as improved capacitance and ESR values. Notably, the ultracapacitor may exhibit excellent electrical properties even when exposed to high temperatures. For example, the ultracapacitor may be placed into contact with an atmosphere having a temperature of from about 80° C. or more, in some embodiments from about 100° C. to about 150° C., and in some embodiments, from about 105° C. to about 130° C. (e.g., 85° C. or 105° C.). The capacitance and ESR values can remain stable at such temperatures for a substantial period of time, such as for about 100 hours or more, in some embodiments from about 300 hours to about 5000 hours, and in some embodiments, from about 600 hours to about 4500 hours (e.g., 168, 336, 504, 672, 840, 1008, 1512, 2040, 3024, or 4032 hours).

In one embodiment, for example, the ratio of the capacitance value of the ultracapacitor after being exposed to the hot atmosphere (e.g., 85° C. or 105° C.) for 1008 hours to the capacitance value of the ultracapacitor when initially exposed to the hot atmosphere is about 0.75 or more, in some embodiments from about 0.8 to 1.0, and in some embodiments, from about 0.85 to 1.0. Such high capacitance values can also be maintained under various extreme conditions, such as when applied with a voltage and/or in a humid atmosphere. For example, the ratio of the capacitance value of the ultracapacitor after being exposed to the hot atmosphere (e.g., 85° C. or 105° C.) and an applied voltage to the initial capacitance value of the ultracapacitor when exposed to the hot atmosphere but prior to being applied with the voltage may be about 0.60 or more, in some embodiments from about 0.65 to 1.0, and in some embodiments, from about 0.7 to 1.0. The voltage may, for instance, be about 1 volt or more, in some embodiments about 1.5 volts or more, and in some embodiments, from about 2 to about 10 volts (e.g., 2.1 volts). In one embodiment, for example, the ratio noted above may be maintained for 1008 hours or more. The ultracapacitor may also maintain the capacitance values noted above when exposed to high humidity levels, such as when placed into contact with an atmosphere having a relative humidity of about 40% or more, in some embodiments about 45% or more, in some embodiments about 50% or more, and in some embodiments, about 70% or more (e.g., about 85% to 100%). Relative humidity may, for instance, be determined in accordance with ASTM E337-02, Method A (2007). For example, the ratio of the capacitance value of the ultracapacitor after being exposed to the hot atmosphere (e.g., 85° C. or 105° C.) and high humidity (e.g., 85%) to the initial capacitance value of the ultracapacitor when exposed to the hot atmosphere but prior to being exposed to the high humidity may be about 0.7 or more, in some embodiments from about 0.75 to 1.0, and in some embodiments, from about 0.80 to 1.0. In one embodiment, for example, this ratio may be maintained for 1008 hours or more.

The ESR can also remain stable at such temperatures for a substantial period of time, such as noted above. In one embodiment, for example, the ratio of the ESR of the ultracapacitor after being exposed to the hot atmosphere (e.g., 85° C. or 105° C.) for 1008 hours to the ESR of the ultracapacitor when initially exposed to the hot atmosphere is about 1.5 or less, in some embodiments about 1.2 or less, and in some embodiments, from about 0.2 to about 1. Notably, such low ESR values can also be maintained under various extreme conditions, such as when applied with a high voltage and/or in a humid atmosphere as described above. For example, the ratio of the ESR of the ultracapacitor after being exposed to the hot atmosphere (e.g., 85° C. or 105° C.) and an applied voltage to the initial ESR of the ultracapacitor when exposed to the hot atmosphere but prior to being applied with the voltage may be about 1.8 or less, in some embodiments about 1.7 or less, and in some embodiments, from about 0.2 to about 1.6. In one embodiment, for example, the ratio noted above may be maintained for 1008 hours or more. The ultracapacitor may also maintain the ESR values noted above when exposed to high humidity levels. For example, the ratio of the ESR of the ultracapacitor after being exposed to the hot atmosphere (e.g., 85° C. or 105° C.) and high humidity (e.g., 85%) to the initial capacitance value of the ultracapacitor when exposed to the hot atmosphere but prior to being exposed to the high humidity may be about 1.5 or less, in some embodiments about 1.4 or less, and in some embodiments, from about 0.2 to about 1.2. In one embodiment, for example, this ratio may be maintained for 1008 hours or more.

The ultracapacitor may also have a relatively low leakage current. In general, “leakage current” is the amount of current which flows through the capacitor at a given DC voltage, for example at the rated DC voltage of the ultracapacitor. In this regard, when tested at 70° C. with an output current of 100 amps and 48 V, the maximum leakage current may be 100 mA or less, such as 80 mA or less, such as 50 mA or less, such as 45 mA or less, such as 40 mA or less, such as 30 mA or less, such as 20 mA or less, such as 10 mA or less.

### Test Methods

Equivalent Series Resistance (ESR): Equivalence series resistance may be measured using a Keithley 3330 Precision LCZ meter with a DC bias of 0.0 volts, 1.1 volts, or 2.1 volts (0.5 volt peak to peak sinusoidal signal). The operating frequency is 1 kHz. A variety of temperature and relative humidity levels may be tested. For example, the temperature may be 23° C., 85° C. or 105° C., and the relative humidity may be 25% or 85%.

Capacitance: The capacitance may be measured using a Keithley 3330 Precision LCZ meter with a DC bias of 0.0 volts, 1.1 volts, or 2.1 volts (0.5 volt peak to peak sinusoidal signal). The operating frequency is 120 Hz. A variety of temperature and relative humidity levels may be tested. For example, the temperature may be 23° C., 85° C. or 105° C., and the relative humidity may be 25% or 85%.

These and other modifications and variations of the present invention may be practiced by those of ordinary skill in the art, without departing from the spirit and scope of the present invention. In addition, it should be understood that aspects of the various embodiments may be interchanged both in whole or in part. Furthermore, those of ordinary skill in the art will appreciate that the foregoing description is by way of example only, and is not intended to limit the invention so further described in such appended claims.

What is claimed is:

1. A data center rack comprising:
a plurality of chamber openings including computing devices; and
at least one chamber opening including a mounted ultracapacitor module comprising a plurality of ultracapacitors.

2. The data center rack of claim 1, wherein the ultracapacitor module has an output voltage of from 12 V to 100 V.

3. The data center rack of claim 1, wherein the ultracapacitor module has an output voltage of 48 V.

4. The data center rack of claim 1, wherein the ultracapacitor module has a leakage current of 50 mA or less at a rated voltage and temperature of 70° C.

5. The data center rack of claim 1, wherein the ultracapacitor module has a capacitance of from 50 F to 1,000 F.

6. The data center rack of claim 1, wherein the ultracapacitors have a capacitance of from 500 F to 5,000 F.

7. The data center rack of claim 1, wherein the ultracapacitor module includes from 18 to 60 ultracapacitors.

8. The data center rack of claim 1, wherein the ultracapacitor module includes at least three banks of ultracapacitors each comprising the ultracapacitors.

9. The data center rack of claim 1, wherein the ultracapacitor module includes more than one bank of ultracapacitors, wherein the more than one banks are electrically connected in parallel.

10. The data center rack of claim 1, wherein the ultracapacitor module includes a switch mode power supply.

11. The data center rack of claim 1, wherein the ultracapacitor module includes a converter.

12. The data center rack of claim 1, wherein the ultracapacitor module includes a buck converter, a boost converter, or a buck/boost converter.

13. The data center rack of claim 1, wherein the ultracapacitor module includes external terminals for electrical connection to the computing devices.

14. A data center comprising the data center rack of claim 1.
